(19) United States
(12) Patent Application Publication
(10) Pub. No.: US 2008/0010113 A1
(43) Pub. Date: Jan. 10, 2008

(54) System and method for a multi-level affinity network

(75) Inventors: Samuel Tod (Bo) Lanter JR., Lexington, KY (US); Robert B. Trussell JR., Lexington, KY (US)

Correspondence Address: THOMAS, KAYDEN, HORSTEMEYER & RISLEY, LLP, 600 GALLERIA PARKWAY, STE 1500, ATLANTA, GA, 30339, US

(73) Assignee: Samuel Tod Lanter

(21) Appl. No.: 11/415,539

(22) Filed: May 2, 2006

Related U.S. Application Data
(60) Provisional application No. 60/677,795, filed on May 4, 2005.

(51) Int. Cl. G07G 1/14

(52) U.S. Cl. 705/14

(57) ABSTRACT

A method for administering a benefits network includes receiving transaction information from a provider that includes information about a transaction between the provider and a member, executing a benefit algorithm configured to determine a benefit resulting from the transaction, transferring transaction information to the provider that includes information about the benefit resulting from the transaction, receiving the benefit from the provider, executing a recipient algorithm configured to allocate the benefit among one or more recipients using a hierarchy of members of the network, the hierarchy including an upper line for each member, the upper line of the member including other members of the network that are affiliated with the member and have higher priority in the network than the member, the recipients including the member that entered the transaction and other members in the upper line of the member, and dispersing the benefit among the recipients.

### CROSS-REFERENCE TO RELATED APPLICATIONS

The present application claims the benefit of copending U.S. provisional application entitled “System and Method for Multi-level Marketing”, having Ser. No. 60/677,795, filed May 4, 2005, the contents of which are entirely incorporated by reference herein.

### BACKGROUND

The present invention is directed to various embodiments of systems and methods for novel affinity networks that embody multi-level marketing approaches. A multi-level marketing organization is a sales network in which salesmen both sell product and recruit others to sell product. Each salesman is compensated for his owns sales and for sales by those he recruited. An example of a successful multi-level marketing organization is Amway. However, multi-level marketing exhibits disadvantages. For example, salesmen have incentive to recruit additional salesmen into the sales force, but buyers have no incentive to prefer purchasing from the sales force to purchasing from unaffiliated third parties. This imbalance causes the sales force to grow at a relatively faster rate than the buyer pool. With many salesmen competing to sell the same products to limited buyers, salesmen often lose interest, causing a high “chum rate” or attrition rate of salesmen that no longer choose to participate. Thus, multi-level marketing succeeds in encouraging recruitment of additional sellers but fails to encourage recruitment of additional buyers. Further, buyers and sellers tend to lack loyalty to the organization.

In contrast, buyers and sellers may remain loyal to an affinity network or a reward program, but may lack motivation to recruit additional buyers. An affinity network is a benefit program in which a pool of sellers offers incentives to a pool of buyers to gain access to the buyers. An example affinity network is a discount program resulting from an auto club membership. Similarly, a reward or loyalty program is a benefit program in which an individual seller offers incentives to an individual buyer. An example reward program is a frequent flier program offered by an airline. Affinity networks and reward programs engender loyalty from buyers that want the incentives, and from sellers that want access to the buyers. However, neither model encourages recruitment of additional buyers into the network. Further, buyers may be unable to share accrued discounts and rewards with third parties, such as family members, friends, or charitable or public service organizations, despite a desire to do so.

From the above, an apparent need exists for a marketing system and method in which participants are motivated to both remain loyal to the network and to recruit additional buyers into the network. Further, it may be advantageous to enable members to contribute accrued benefits to third-parties, such as trusts, charitable organizations, public service organizations, or other entities.

### SUMMARY

A method for administering a benefits network includes receiving transaction information from a provider of the network that includes information about a transaction between the provider and a member of the network, executing a benefit algorithm configured to determine a benefit resulting from the transaction, transferring transaction information to the provider that includes information about the benefit resulting from the transaction determined by executing the benefit algorithm, receiving the benefit from the provider, executing a recipient algorithm configured to allocate the benefit among one or more recipients using a hierarchy of members of the network, the hierarchy including an upper line for each member, the upper line of the member including other members of the network that are affiliated with the member and have higher priority in the network than the member, the recipients including the member that entered the transaction and other members in the upper line of the member that entered the transaction, and dispersing the benefit among the recipients.

In one embodiment, a computer readable medium having a program for administering a benefits network includes logic configured to receive transaction information from a provider of the network that includes information about a transaction between the provider and a member of the network, logic configured to execute a benefit algorithm that is configured to determine a benefit resulting from the transaction, logic configured to transfer transaction information to the provider that includes information about the benefit resulting from the transaction determined by executing the benefit algorithm, logic configured to receive the benefit from the provider, logic configured to execute a recipient algorithm that is configured to allocate the benefit among one or more recipients using a hierarchy of members of the network, the hierarchy including an upper line for each member, the upper line of the member including other members of the network that are affiliated with the member and have higher priority in the network than the member, the recipients including the member that entered the transaction and other members in the upper line of the member that entered the transaction, and logic configured to disperse the benefit among the recipients.

In one embodiment, a system for administering a benefits network includes a repository of information about the network having member information that includes an identifier for each member of the network and a hierarchy of members of the network that describes the relationship of members to other members, each member having an upper line in the hierarchy, the upper line of the member including other members that are affiliated with the member and that have higher priority in the network than the member, provider information that includes an identifier for each provider of the network, and transaction information that includes information about a transaction between the member and provider, and the system also includes a benefit algorithm configured to determine a benefit resulting from the transaction using information input from the repository, a repository of benefits configured to store the benefit, and a recipient algorithm configured to allocate the benefit among recipients using information input from the repository of information, wherein the recipients include the member that entered the transaction and other members in the upper line of the member that entered the transaction.

Other systems, devices, features, and advantages of the disclosed system and method will be or will become apparent to one with skill in the art upon examination of the following drawings and detailed description. All such additional systems, devices, features, and advantages are intended to be included within this description, are intended to be included within the scope of the present invention, and are intended to be protected by the accompanying claims.

### BRIEF DESCRIPTION OF THE DRAWINGS

The present disclosure may be better understood with reference to the following drawings. Matching reference numerals designate corresponding parts throughout the Figures, and components in the drawings are not necessarily to scale.

FIG. 1 illustrates an embodiment of a system for administering a benefits network.

FIG. 2 is a diagram illustrating an embodiment of a hierarchy of members of the network.

FIG. 3 is a diagram illustrating an embodiment of a method for administering a benefits network.

FIG. 4 is an example general-purpose computer that can be used to implement an embodiment of the system for administering a benefits network that is illustrated in FIG. 1.

FIG. 5 illustrates a second embodiment of a system for administering a benefits network.

FIG. 6 illustrates a third embodiment of a system for administering a benefits network.

FIG. 7 illustrates an embodiment of a method for administering a benefits network.

### DETAILED DESCRIPTION

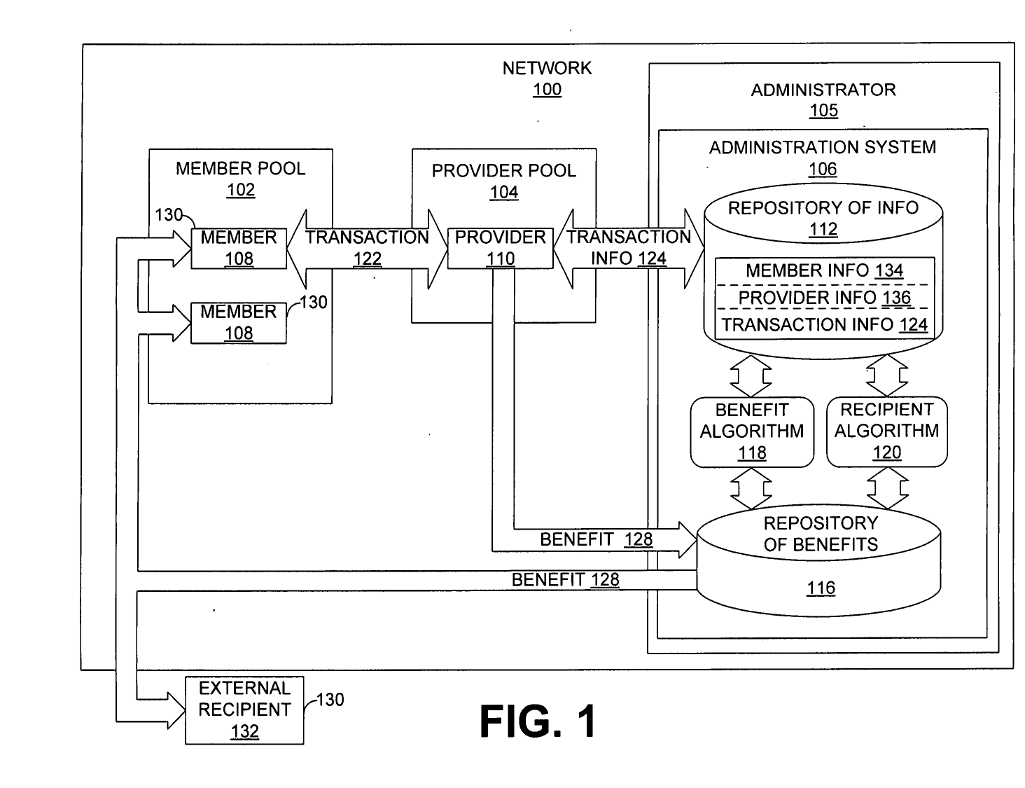

FIG. 1 illustrates a system for administering a benefits network such that participants in the network are motivated to both remain loyal to the network and to recruit additional members into the network. Generally speaking, the network 100 includes a member pool 102, a provider pool 104, and an administrator 105 that includes an administration system 106. The member pool 102 includes one or more members 108 that have joined the network. The provider pool 104 includes one or more providers 110 that have joined the network. The administration system 106 includes a repository of information 112, a repository of benefits 116, a benefit algorithm 118, and a recipient algorithm 120.

The flow of data throughout the system is also illustrated in FIG. 1. Generally speaking, a member 108 from the member pool 102 enters into a transaction 122 with a provider 110 from the provider pool 104. Transaction information 124 related to the transaction is sent from the provider 110 to the administrator 105. The benefit algorithm 118 uses information from the repository of information 112 to determine a benefit 128 resulting from the transaction 122. Transaction information 124 is returned to the provider 110 from the repository of information 112, the transaction information including the benefit 128 resulting from the transaction 122 as determined by the benefit algorithm 118. The provider 110 sends the benefit 128 resulting from the transaction to the administrator 105, and the benefit is added to the repository of benefits 116. The recipient algorithm 120 uses information from the repository of information 112 to allocate the benefit 128 resulting from the transaction among one or more recipients 130. The administrator 105 then distributes the benefit 128 among the recipients 130 that were determined by the recipient algorithm 120. The recipients 130 may include the member 108 that entered the transaction 122, other members 108 of the network that are affiliated with the member that entered the transaction and have higher priority in the network than the member that entered the transaction, and/or external recipients 132. Other members that are recipients based on affiliation and priority may be determined from a recruiting chain of the member that entered the transaction. External recipients may be third parties, such as non-profit organizations, unincorporated associations, or trusts or funds for charitable purposes.

The member pool 102 includes one or more members 108 that may be, for example, individuals or business entities that intend to enter transactions 122 with providers 110 and to receive benefits 128 as a result of the transactions. To join the network 100, the member 108 satisfies eligibility requirements. In some embodiments, the member becomes eligible to join the network merely by providing personal information to the administrator 105. In other embodiments, eligibility to join the network requires additional consideration from the member. For example, to be eligible the member may be required to pay an initiation fee into the network, to sign up for a credit card affiliated with the administrator, or to purchase a product or service offered by the administrator. The member also provides identifying information to the administrator.

Once a member has joined, the administrator 105 gives the member 108 an identifier that uniquely identifies the member within the network 100. For example, the identifier may be a unique number. The identifier may be used to associate benefits 128 resulting from transactions 122 with providers 104 with members 108 that entered the transactions. In some embodiments, the member may provide the provider his identifier at the time of the transaction. For example, the administrator may assign the member a membership card having the identifier, and the member may present the card at the time of a transaction. The identifier can be physically marked on the card, or electronically or magnetically stored on the card. In some cases, the card may be a cash card that the member can load, and in some cases reload, with cash. In other embodiments, the administrator may correlate the member with his identifier after the transaction has occurred. For example, the administrator may determine the identifier of the member from a credit card number used for the transaction, if the member has registered that credit card number with the administrator.

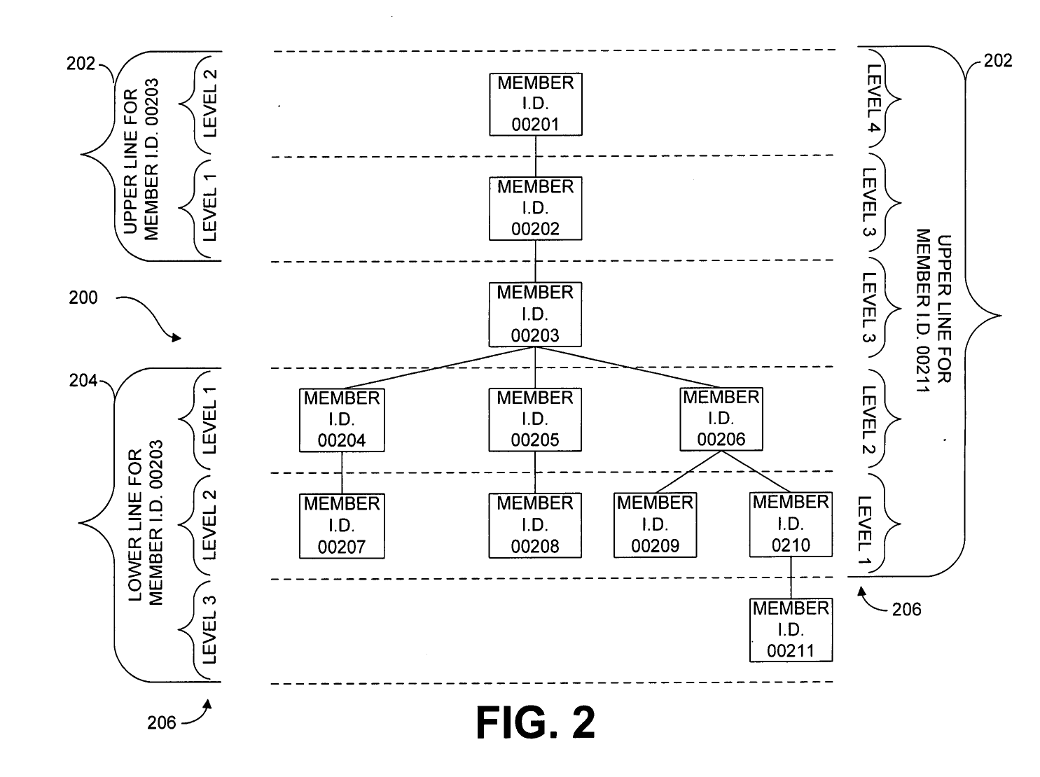

Each member 108 may be affiliated with other members 108 of the member pool 102, and members may have priority within the network 100 with respect to each other. With reference to FIG. 2, the administrator 105 maintains a hierarchy 200 of members of the network that describes the affiliation and priority relationships among members of the network. The hierarchy may organize members using, for example, the identifier of the member. Each member may be affiliated with other members that are above him in hierarchy and have higher priority in the network. These members comprise his upper line 202 in the hierarchy 200. Likewise, the member may be affiliated with other members that are below him in the hierarchy and have lower priority in the network. These members comprise his lower line 204in the hierarchy 200.

In some embodiments, the upper line 202 and lower line 204 may have levels 206 that organize the priority relationships among members 108. Within the upper line 202 or the lower line 204 of a given member, other members that have the same priority with respect to the given member may be assigned to the same level, which may be higher or lower than the level of other members within the line depending on the priority relationships among the members within the line with respect to each other. For example, in FIG. 2, the member having identifier 00203 may have a lower priority in the network than the member having identifier 00202, and the member having identifier 00202 may have lower priority in the network than the member having identifier 00201. Thus, for any given member, the hierarchy indicates the members with which he is affiliated, his priority with respect to the members with which he is affiliated, and the priority of each member with which he is affiliated with respect to the other members with which he is affiliated.

Depending on the member 108 and his affiliation with other members, the upper line 202 and lower line 204 of the member may vary. A member that is affiliated with other members that have higher priority and with other members that have lower priority may have members in both his upper and lower line. In other cases, the upper line or the lower line of a member may be empty. In FIG. 2, for example, the member having member I.D. 00203 has both an upper and a lower line, but the upper line of the member having member I.D. 00201 is empty.

If a member becomes affiliated with other members, the hierarchy may be adjusted to account for this relationship by creating an upper line or a lower line or by adding a new relationship in an existing upper or lower line, as is appropriate. If the affiliation between members ends, the hierarchy may be adjusted to delete the relationship. A single member may occupy multiple positions in the hierarchy, such as being in the upper line of one member while simultaneously being in the lower line of another member. Further, multiple members may have the same priority in the network without appearing in the same upper or lower lines, if the members are not affiliated with each other.

While affiliation and priority among members may be based on any requirement, in some embodiments, affiliation and priority is based on recruitment into the network. In such an embodiment, a member is affiliated with other members based on a recruiting connection, such as a member having recruited another member into the network or the member having been recruited by another member into the network. Further, a member has lower priority than the members that were recruited into the network before him do, and the member has higher priority than members that were recruited into the network after him do.

In such an embodiment, the upper line 202 of a member 108 may describe the recruiting chain above the member. If the member has a recruiting connection with other members that were recruited into the network before him, those members appear in his upper line. A member may have been recruited by the member one level 206 above him in the upper line, and the member one level upper him may have been recruited by the member two levels above him. This pattern continues until the recruiting chain above the member ends. Therefore, the upper line may have a variable number of levels depending on the recruiting chain, and the upper line of the member is established when he joins the network. However, members that subsequently leave the network may be deleted from the upper line.

For example, in FIG. 2, the member having identifier 00203 may have been recruited into the network by the member having identifier 00202, and the member having identifier 00202 may have been recruited by the member having identifier 00201. Similarly, the upper line 202 of the member having identifier 00211 may include the members having identifiers 00210, 00206, 00203, 00202, and 00201.

The lower line 204 of a member 108 may describe the recruiting chain below the member. If the member has a recruiting connection with other members that were recruited into the network after him, those members appear in his lower line. The lower line may have a variable number of levels depending on the recruiting chain below the member. A member may have recruited the member one level below him in his lower line, and the member one level below him may have recruited the member two levels below him. For example, in FIG. 2, the member having identifier 00203 may have recruited the members having identifiers 00204, 00205, and 00206. The member having identifier 00204 may have recruited the member having identifier 00207, and this pattern continues until the recruiting chain below the member ends. Once the lower line is established, it continues to grow as the member recruits additional new members and as those members recruit additional new members, all of which become part of the lower line.

In some cases, a member may have been recruited by multiple members into the network, and may recruit multiple members into the network. In such cases, the member may have multiple members one level above him in his upper line or one level below him in his lower line.

With reference back to FIG. 1, a member 108 can perform several functions within the network 100, including recruiting additional members 108 into the member pool 102 and entering transactions 122 with the providers 110 in the provider pool 104. In some embodiments, members may provide member settings to the administrator 105 that indicate preferences of the member. The administrator may use the member settings, for example, when determining benefits 128 that result from transactions between the member and the provider and when allocating those benefits to recipients 130.

The provider pool 104 includes one or more providers 110 that have joined the network 100. Each provider may be an entity that anticipates entering transactions 122 with members 108 and that intends to return benefits 128 as a consequence of those transactions. A transaction 122 may be an exchange of value between a member 102 and a provider 104, such as a point of sale transaction. For example, the provider may be a merchant that intends to sell goods or a service provider that intends to provide a service to the member in exchange for money, and as a result of the transaction intends to return a benefit to the network. In some embodiments, additional providers may be envisioned whose participation in the network is not premised on providing members with a good or service. In such an embodiment, the transaction between the member and the provider may not involve an exchange of value.

To join the network, the provider 110 supplies identifying information to the administrator 105 and receives an identifier from the administrator that uniquely identifies the provider within the network, such as a unique number. Benefit rules are also established for the provider, such that when the provider enters a transaction with a member, the provider returns a benefit as determined by the benefit rules. While in some embodiments the provider becomes eligible to join the network by providing information to the administrator and establishing benefit rules, eligibility to join the network requires additional consideration in other embodiments. For example, the provider may be required to enter a contract with the administration system that requires the provider to honor the benefit rules. Thus, providers 110 can perform several functions within the network including entering transactions 122 with members 108 from the member pool 102 and returning benefits 128 as determined by the benefit rules.

The administrator 105 administers the network 100. The administrator may also be a member 108 or a provider 110 within the network 100. For example, the administrator may be a merchant or a service provider that provides a base product or service to the member, or a credit card company that provides a credit card to the member. As mentioned above, the member may be required to purchase the product or service or to receive the credit card as a condition of eligibility for the network.

The administrator 105 performs several functions within the network 100, including overseeing the implementation of the administration system 106. This may include maintaining the repository of information 112 and repository of benefits 116, and overseeing the implementation of the benefit algorithm 118 and the recipient algorithm 120.

The repository of information 112 includes member information 134, provider information 136, and transaction information 124. The member information 134 includes information about the member pool 102, such as the identifier for each member 108 and the personal information supplied by the member when joining the network. The member information 134 also includes information from which the hierarchy of members of the network is constructed. In cases in which the hierarchy is the hierarchy 200 shown in FIG. 2, the member information 134 includes the identifier of a member, the identifiers of members in his upper line 202 and lower line 204, and the levels 206 of those members with respect to each other.

The provider information 136 includes information about the provider pool 104, such as the identifier for each provider 110, the information supplied by the provider when joining the network and, in some cases, the benefit rules associated with the provider. The transaction information 124 includes information about transactions 122 between members 108 and providers 110, such as the identifier of the member and the identifier of the provider, the value of the transaction, the benefit 128 to be returned by the provider for the transaction, and the recipients 130 of the benefit. Other information such as the date, time, and location of the transaction and how the member paid for the transaction may also be included in the transaction information. The transaction information 124 may be gathered in a variety of manners. For example, some of the transaction information may be supplied from the provider 110, some may be output from the benefit algorithm 118, and some may be output from the recipient algorithm 120.

Although the repository of information 106 has been described above as including specific information, additional information may be included in or omitted from the repository as is needed for administering the network. Further, the repository of information can be any system for storing information that facilitates retrieving the information for use in executing the benefit algorithm and the recipient algorithm.

The repository of benefits 116 is a repository for storing and tracking benefits 128 transferred to the administrator 105 by providers 110. The repository of benefits may include, for example, bank accounts, computer systems, and warehouses.

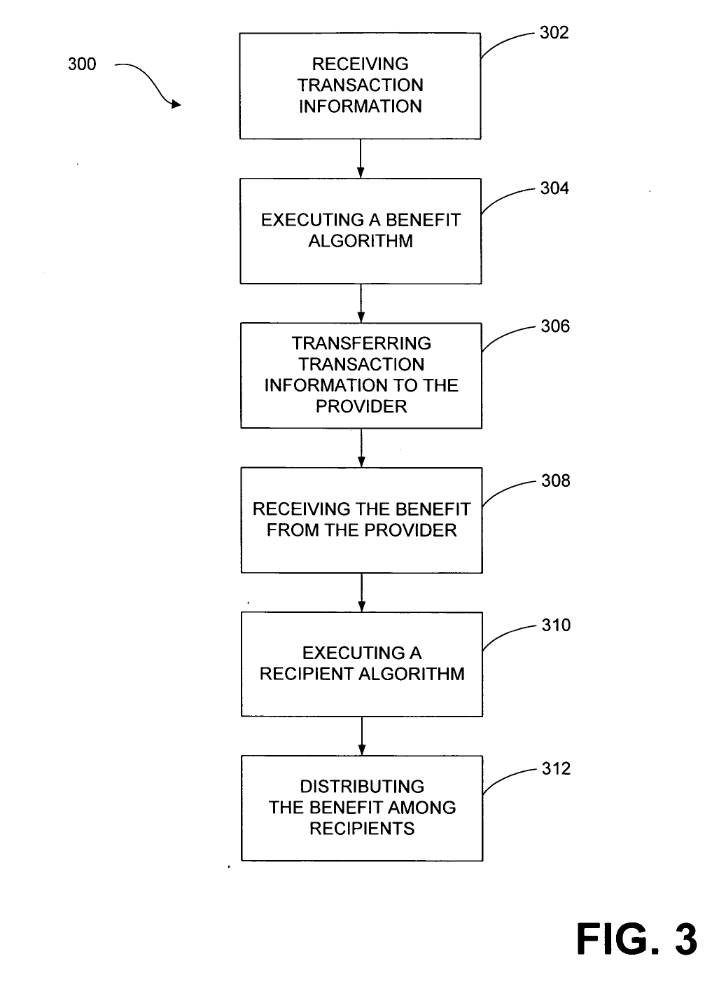

The benefit algorithm 118 is configured to determine the benefit 128 resulting from a transaction 122 between a provider 110 and a member 108 of the network 100, as described below in connection with FIG. 3. To accomplish this, the benefit algorithm applies benefit rules to information from the repository of information. For monetary benefits, a variety of benefit rules are envisioned. The benefit rules may calculate a benefit that is a percentage of the value of a transaction or a flat-fee per transaction. The benefit may also be a combination of a percentage of the value of the transaction and a flat-fee for the transaction.

Non-monetary benefits are also envisioned, such as additional goods or services, or a reward in cases in which the provider administers a reward system. In such cases, the benefit rules may not be a mathematical calculation. For example, the benefit rules for a provider that is a grocery store may return a benefit in the form of groceries, the benefit rules for a provider that is a cable television provider may return benefits in the form of cable television services, and the benefit rules for a provider that is an airline may return benefits in the form of frequent flier miles.

In some cases, the benefit rules may require the member to enter more than one transaction before returning a benefit, in which case historical information about transactions between the member and provider are input into the benefit algorithm for use in applying the benefit rule. Additionally, the benefit rule may vary depending on transaction information supplied to the benefit algorithm. For example, the benefit rules may return different benefits for transactions entered at different times, by different members, or at different locations. Such benefit rules may enable providers to steer members toward a struggling location or to a location having lower overhead, such as an Internet site. The benefit rules may also return different benefits depending on the method of payment used by the member. Such a benefit rule may enable a provider to encourage cash payments by returning a larger benefit to members that pay in cash.

In some cases, the benefit rules may consider member settings in determining the benefit, in which case member information 134 from the repository of information 112 is input into the benefit algorithm 118. For example, the user may indicate his preference for checks over gift certificates in his member settings, and this preference may be considered if the provider is willing to return a benefit in the form of either a gift certificate or a check.

These examples are merely illustrations of benefit rules that may be applied by the benefit algorithm to determine the benefit 128 resulting from a transaction. Any of a variety of benefit rules could be employed that determine benefits based on transaction information 124 and other information in the repository of information 112. Such benefit rules would be apparent to a person of ordinary skill and are intended to be included within the scope of this disclosure.

The recipient algorithm 120 is configured to allocate the benefit 128 resulting from a transaction 122 among recipients 130. The recipients 130 may include, for example, the member 108 that entered the transaction 122 with the provider and other members 130 within the upper line 202 of the member. Therefore, the network 100 is designed to return benefits to multiple recipients 130 for the transaction of a single member 108. Those recipients may include the member himself and other members with which he is affiliated that have priority over him within the network.

In embodiments in which the hierarchy is organized based on recruiting connections, allocating the benefit among the member that entered the transaction and the members of his upper line is equivalent to allocating the benefit among the member that entered the transaction and the members in the recruiting chain above the member. The recruiting chain above the member includes other members that have a recruiting connection to the member and were recruited into the network before the member. These members appear in the upper line of the member that entered the transaction. In FIG. 2, for example, the recipient algorithm may allocate a benefit for a transaction entered by member 00203 among the members of the recruiting chain above the member, such as members 00202 and 00201.

In other embodiments, the recipient algorithm may be configured to allocate the benefit to recipients other than the member that entered the transaction and the members within his upper line. For example, the recipient algorithm may allocate the benefit among the upper line only, without allocating any portion of the benefit to the member that entered the transaction. Such an embodiment may give a member a relatively high incentive to recruit additional members into the network, which would be required to receive benefits from the network.

In one embodiment, the recipient algorithm 120 may be configured to allocate the benefit 128, or a portion of the benefit, to external recipients 132. The external recipient may be a third party that is not necessarily affiliated with the network 100, such as a non-profit organization, a charitable organization, a public service organization, a community service organization, an unincorporated association committed to a cause, a trust for a particular purpose, or a fund or pool administered by a third-party. For example, the external recipient may be a fund that campaigns or markets a cause, such as a campaign that seeks to elect a politician or fund that advertises against smoking.

The recipient algorithm 120 may be configured to allocate a percentage of the benefit 128 to each recipient 130. In one embodiment, the benefit may be equally divided among the recipients. In another embodiment, the member that entered the transaction may receive a set percentage of the benefit and the remainder of the benefit may be equally divided among the remaining recipients. In another embodiment, the recipients other than the member that entered the transaction may receive a set percentage of the benefit and the remainder may be allocated to the member that entered the transaction.

In still other embodiments, the recipient algorithm 120 may be configured to allocate among recipients 130 that are in the upper line 202 according to the level 206 associated with those recipients in the upper line. For example, the recipient algorithm may allocate a graduated percentage among the upper line, such that members having the level nearest the member that entered the transaction receive a greater portion of the benefit than the members having the level farthest from the member that entered the transaction. The opposite configuration is also possible, in which the members having the level farthest from the member that entered the transaction receive a greater portion of the benefit. In such case, the members having the highest priority in the network receive the greatest allocation of benefits. These examples are merely illustrations, and other configurations for the recipient algorithm that would be apparent to a person of skill are intended to be included within the scope of this disclosure.

In some cases, the recipient algorithm 118 may consider member settings in allocating the benefit 128, in which case member information 134 from the repository of information 112 is input into the recipient algorithm. For example, the member settings may indicate a preference of the user to disperse his allocation of the benefit to an external recipient 132, such as a fund for a particular purpose.

FIG. 3 illustrates a method 300 for administering a benefits network, such as the network described in connection with FIG. 1. A member and a provider enter a transaction, such as an exchange of goods for money. In block 302 the administration system receives transaction information from the provider for the transaction.

In block 304 the administration system executes a benefit algorithm that is configured to determine the benefit 128 resulting from the transaction. The benefit algorithm receives input information from the repository of information 112, such as transaction information 124 and provider information 136, which may include the benefit rules for the provider 110. The benefit algorithm outputs the benefit 128 resulting from the transaction. Information about the benefit 128, such as the value of a monetary benefit, is added to the transaction information 124 in the repository of information 112.

In embodiments in which each provider 110 uses the same benefit rules, the benefit algorithm 118 may include a single set of benefit rules, and the benefit 128 may be determined by inputting the transaction information 124 into the benefit algorithm. In some embodiments, the benefit algorithm 118 may be executed by the provider 110, and the provider sends information about the benefit 128 with the transaction information 124. Providers 110 may also chose to provide benefits 128 to members 108 that are not required by the benefit algorithm 118, or are in addition to the benefit returned by the benefit algorithm. For example, a provider may chose to provide members with a discount or a free gift at the point of sale in lieu of or in addition to the benefit returned by the benefit algorithm.

In block 306 the administration system transfers transaction information to the provider 110, including information about the benefit determined by the benefit algorithm. The provider than returns the benefit to the repository of benefits 116, and the administration system receives the benefit into the repository of benefits in block 308.

The administration system 106 executes the recipient algorithm 120 in block 310, which is configured to allocate the benefit 128 resulting from the transaction among one or more recipients 130. The recipient algorithm 120 receives input information from the repository of information 112, including transaction information 124, such as the benefit 128 determined by the benefit algorithm 118, and member information 134, such as the hierarchy 200 of members of the network. The recipient algorithm 120 outputs recipients 130 that are entitled to receive a portion of the benefit 128, and the portion to which each recipient is entitled, as described above. The information is added to the transaction information 124 in the repository of information 112. The administration system then distributes the benefit among the recipients 130 in block 312.

In another embodiment, the provider may return the benefit directly to the recipient. In such a case, the provider may not return the benefit to the repository of benefits, and the administrator may not disperse the benefit among the recipients. For example, a provider that administers a rewards program such as a frequent flier program may deliver the benefit to the recipient by crediting an account of the recipient.

The method 300 may be implemented on a transaction by transaction basis, as described above. In other embodiments, some steps of the method may be aggregated for a series of transactions. For example, the administration system may receive transaction information from the provider on a periodic basis in the form of a report that summarizes transactions throughout a period. Similarly, the administration system may transfer transaction information to the provider on a periodic basis, in the form of a report that summarizes benefits accrued over the period. The administration system may receive an aggregate benefit from the provider for the period, and may associate the aggregate benefit with individual transactions 122. Further, the administration system may transfer benefits to recipients on a periodic basis. The transfer of benefits may include a report summarizing the benefits dispersed for the period.

Embodiments of the system for administering a benefits network within a network described in FIG. 1 and FIG. 3 can be implemented in software, firmware, hardware, or combinations thereof. Furthermore, the components of the system can reside on one computer system, or can be distributed among more than one computer system. In some embodiments, the system is implemented in software, as an executable program or programs, and is executed by a special or general-purpose digital computer, or combination of computers, such as a personal digital assistant (PDA) or personal computer (PC).

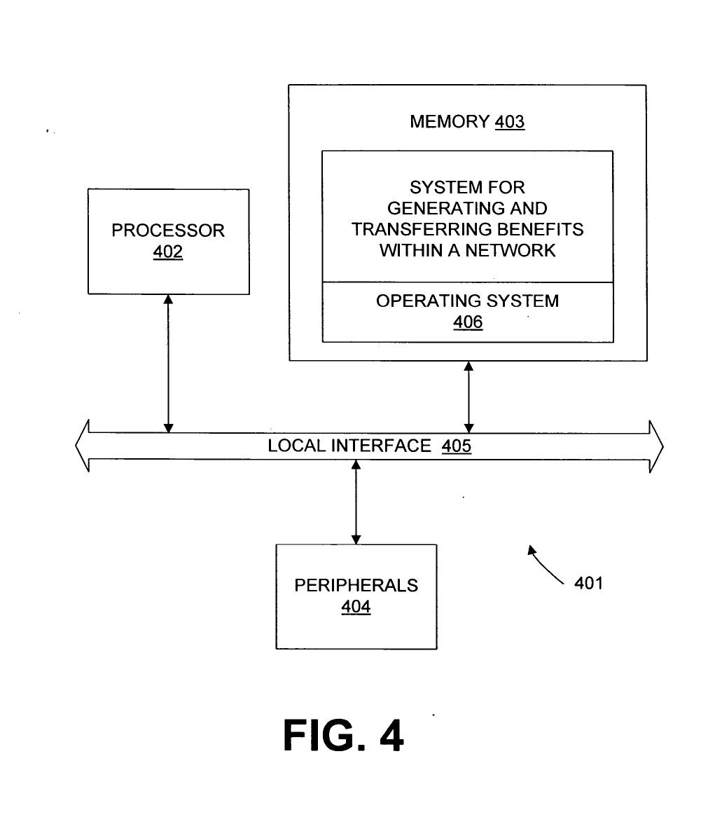

FIG. 4 is a block diagram of a general-purpose computer system that can be used to implement embodiments of the system and method for administering a benefit network. Generally, in terms of hardware architecture, the computer 401 includes a processor 402, memory 403, and one or more input or output (I/O) devices or peripherals 404 that are communicatively coupled via a local interface 405. The local interface 405 can be, for example but not limited to, one or more buses or other wired or wireless connections, as is known in the art. The local interface 405 may have additional elements (omitted for simplicity), such as controllers, buffers, drivers, repeaters, and receivers, to enable communications. Further, the local interface 405 may include address, control, and data connections to enable appropriate communications among the aforementioned components.

The processor 402 is a hardware device for executing software, particularly that stored in memory 403. The processor 402 can be any custom made or commercially available processor, a central processing unit (CPU), an auxiliary processor among several processors resulting from the computer 401, a semiconductor based microprocessor (in the form of a microchip or chip set), a microprocessor, or generally any device for executing software instructions.

The memory 403 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 403 may incorporate electronic, magnetic, optical, or other types of storage media. Note that the memory 403 can have a distributed architecture, where various components are situated remote from one another, but can be accessed by the processor 402.

The software in memory 403 may include one or more separate programs, each of which comprises an ordered listing of executable instructions for implementing logical functions. In the example of FIG. 4, the software in the memory 403 includes one or more components of the system for administering a benefits network, and a suitable operating system 406. The operating system 406 essentially controls the execution of other computer programs, such as the system for administering a benefits network, and provides scheduling, input-output control, file and data management, memory management, and communication control and related services.

The system for administering a benefits network may be a source program, executable program (object code), script, or any other entity comprising a set of instructions to be performed. When a source program, the program needs to be translated via a compiler, assembler, interpreter, or the like, which may or may not be included within memory 403, so as to operate properly in connection with the operating system 406.

The peripherals 404 may include input devices, for example but not limited to, a keyboard, mouse, scanner, microphone, etc. Furthermore, the peripherals 404 may also include output devices, for example but not limited to, a printer, display, facsimile device, etc. Finally, the peripherals 404 may further include devices that communicate both inputs and outputs, for instance but not limited to, a modulator/demodulator (modem; for accessing another device, system, or network), a radio frequency (RF) or other transceiver, a telephone interface, a bridge, a router, etc.

If the computer 401 is a PC, workstation, or the like, the software in the memory 403 may further include a basic input output system (BIOS). The BIOS is a set of essential software routines that initialize and test hardware at startup, start the operating system 406, and support the transfer of data among the hardware devices. The BIOS is stored in the ROM so that the BIOS can be executed when the computer 401 is activated.

When the computer 401 is in operation, the processor 402 is configured to execute software stored within the memory 403, to communicate data to and from the memory 403, and to generally control operations of the computer 401 in accordance with the software. The system for administering a benefits network and the operating system 406, in whole or in part, but typically the latter, are read by the processor 402, and perhaps buffered within the processor 402, and then executed.

It should be noted that the system for administering a benefits network can be stored on any computer readable medium for use by or in connection with any computer related system or method. In the context of this document, a “computer-readable medium” can be any means that can store, communicate, propagate, or transport the program for use by or in connection with the instruction execution system, system, or device. The computer-readable medium can be, for example but not limited to, an electronic, magnetic, optical, electromagnetic, infrared, or semiconductor system, system, device, or propagation medium. A non-exhaustive example set of the computer-readable medium would include the following: an electrical connection having one or more wires, a portable computer diskette, a random access memory (RAM), a read-only memory (ROM), an erasable programmable read-only memory (EPROM, EEPROM, or Flash memory), and a portable compact disc read-only memory (CDROM).

In an alternative embodiment, where the system for administering a benefits network is implemented in hardware, it can be implemented with any or a combination of the following technologies, which are each well known in the art: a discrete logic circuit(s) having logic gates for implementing logic functions upon data signals, an application specific integrated circuit(s) (ASIC) having appropriate combinatorial logic gates, a programmable gate array(s) (PGA), a field programmable gate array(s) (FPGA), etc.

Unlike multi-level marketing organizations and prior art affinity networks, participants in the network described above are motivated to both remain loyal to the network and to recruit additional members into the network. A member may remain loyal to the network to receive benefits. Benefits accrue for transactions that are required by day-to-day life such as purchasing goods and services. If a member must perform a transaction, he may prefer to perform the transaction within the network so that he receives a benefit instead of outside the network where receives no benefit. Even if the member no longer intends to enter transactions with network providers, the member may maintain his membership in the network to receive benefits for the transactions of the members in his lower line. Because accruing such benefits requires no affirmative action by the member, he may be unlikely to leave the network.

Further, each member has incentive to expand his lower line by recruiting additional members into the network, which increases his potential for receiving benefits. As the number of members in the member pool increases, the negotiating power of the administrator may also increase. The increased negotiation power may enable the administrator to negotiate more beneficial benefit rules that return larger benefits. Thus, recruiting additional members may increase benefits by increasing the number of transactions for which a member receives benefits and also by increasing the benefit returned per transaction.

Unlike a multi-level marketing organization in which a provider offers a limited range of products and services to a limited pool of buyers, the providers of the network above can offer a wide range of products and services to a growing pool of members. The provider may be less likely to be fatigued by competition with other providers. Thus, the “churn rate” of providers may be lower than in a multi-level marketing organization, and the provider may remain loyal to the network.

In embodiments in which the administrator is a credit card provider and the member is obligated to sign-up for the credit card as a condition of joining the network, the system described above may result in a relatively high strength credit card. Members may favor paying for purchases using the credit card provided by the administrator to receive benefits. In some embodiments, the administrator may disperse or withhold benefits depending on the account status of the member. In cases in which the administrator seeks cash payoffs of accounts, the administrator may require the member to settle the credit card balance before receiving benefits. As a result, the credit card provider may have relatively few delinquent accounts and relatively low collection costs. In cases in which the administrator seeks the accrual of interest, the administrator may disperse benefits without requiring the member to settle the account, or may choose to withhold benefits for delinquent accounts only. In such an embodiment, the above described system and method can be viewed as a system and method for establishing market strength in a credit card.

The system described above advantageously collects a large volume of transaction information that is associated with a single member. In some embodiments, the administrator may analyze the transaction information. The results of this analysis may be used by the administrator to solicit new providers into the network, to negotiate better benefit rules with existing network providers, or to generate profit for the network by selling the transaction information or the results of the analysis to third parties. In cases in which the member information includes member settings, the member may prevent his transaction information from being analyzed or sold by changing his member settings.

While particular embodiments of a network have been disclosed in detail in the foregoing description and drawings for purposes of example, those skilled in the art will understand that variations and modifications may be made without departing from the scope of the disclosure. All such variations and modifications are intended to be included within the scope of the present disclosure, as protected by the following claims.

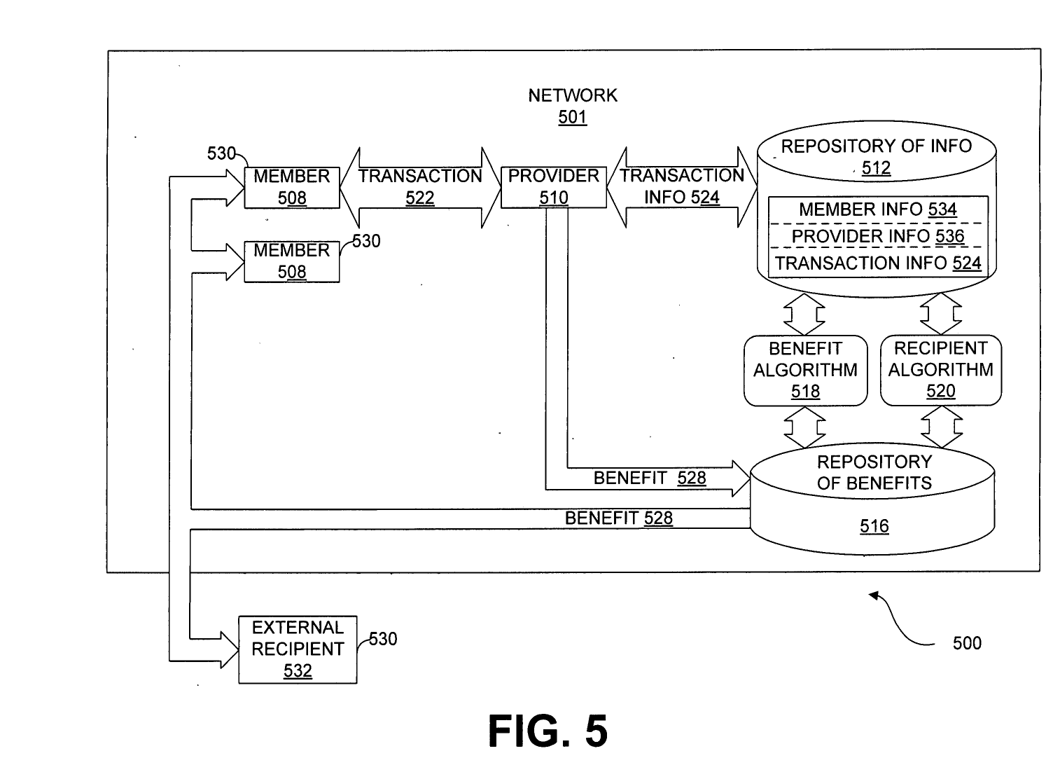

For example, in one embodiment, a system or method is implemented which allocates, accords, or provides certain monetary benefits to a hierarchical lineage of people or entities based on another person's purchase of a good or service. An example of such as system 500 is shown in FIG. 5. A network 501 includes one or more members 508 that enter transactions 522 with one or more providers 510. Transaction info 524 is added to a repository of information 512, which also includes member information 534 and provider information 536. A benefit algorithm 518 is configured to determine a benefit 528 resulting from the transaction 522 based on information in the repository of information 512. A recipient algorithm 520 is configured to allocated the benefit 528 among recipients 530 based on information in the repository of information 512. Benefits 528 from providers 510 are distributed from a repository of benefits 516 to the recipients 530.

The system 500 of allocating benefits can be implemented by an administrator. In other embodiments, the system can be implemented by a single provider, by each provider within a pool of providers, or by one or more providers on behalf of a pool of providers. In such cases, a provider administers the system by determining benefits associated with transactions and allocating and distributing those benefits among individuals or entities in the hierarchy.

The recipients 530 can be any people or entities in a hierarchical lineage that receive an allocation of the benefit based on another person's purchase of a good or service. The hierarchy may include members 508 of the network 501 or external recipients 532 that are not members of the network. Based on the hierarchy, the recipients in FIG. 5 include the member 508 of the network that entered the transaction 522, another member 508 of the network 501, and an external recipient 532 that is not a member of the network. These recipients are shown by way of example, and other hierarchies may result in other recipients. For example, the member that entered the transaction need not be a recipient, a greater or fewer number of other members can be recipients, or there may be a greater of fewer number of external recipients.

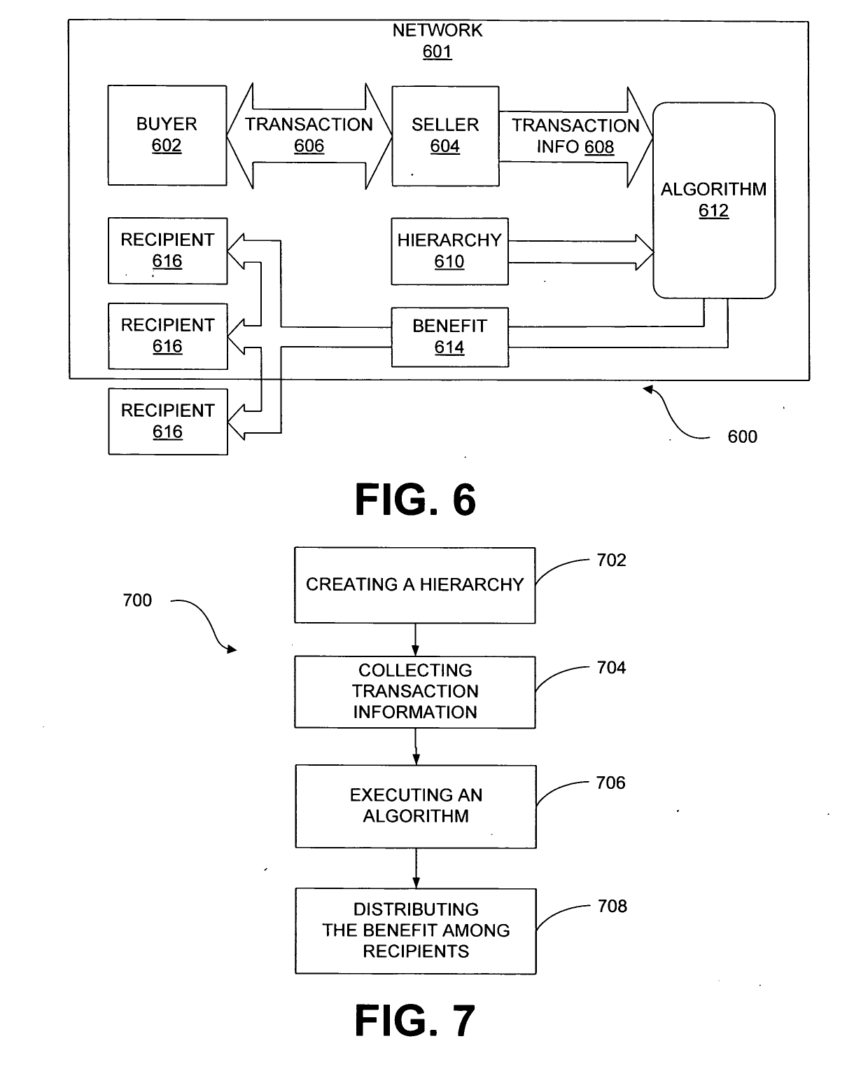

FIG. 6 illustrates another system 600 for administering a benefits network 601. The network 601 includes at least one buyer 602 and at least one seller 604. Sellers 604 include individuals and entities that sell goods or services to buyers 602 as part of transactions 606. Transaction information 608 is input into an algorithm 612 along with a hierarchy 610. The algorithm 612 is configured to determine a benefit 614 resulting from the transaction 606 based on the transaction information 608, and to allocate that benefit among recipients 616 based on the hierarchy 610.

The hierarchy 610 arranges buyers 602 according to an affiliation relationship and priority within the network 601. For example, in one embodiment, affiliation is based on a recruiting relationship and priority is based on date of recruitment into the network.

The recipients 616 can include one or more individuals or entities. The individuals or entities can be the buyer 602 that entered the transaction with the seller 604, other buyers 602, or one or more third-parties that are external to the network 601. Such third-parties may be, for example, friends and/or family of the buyer 602, a non-profit organization, a charitable organization, a public service organization, a community service organization, an unincorporated association, a trust, a fund or a pool of funds.

For example, in the embodiment in which the hierarchy 610 organizes buyers 602 based on a recruiting relationship, each buyer 602 may have a recruiting chain in the hierarchy 610 that links the buyer to other buyers based on a recruiting relationship. The recruiting chain above the buyer 602 includes other buyers that were recruited into the network before him. To determine recipients of a benefit 614 resulting from a transaction 606, the buyer 602 that entered the transaction 606 may receive a portion of the benefit 614, and each buyer 602 in the recruiting chain above him may also share in the benefit. In some cases, a portion of the benefit can also be allocated to the third-party recipients, which may or may not appear in the hierarchy 610.

FIG. 7 illustrates an embodiment of a method for implementing the system shown in FIG. 6. In block 702, the hierarchy 610 is created. In block 704, transaction information 608 about the transaction 606 between the buyer 602 and the seller 604 is collected. In block 612, the algorithm 612 is executed, the algorithm being configured to determine the benefit 614, to determine the recipients 616 of the benefit 614, and to allocate the benefit among the recipients. In block 708, the benefit 614 is distributed among the recipients 616.

1. A method for administering a benefits network comprising:
receiving transaction information from a provider of the network that includes information about a transaction between the provider and a member of the network;
executing a benefit algorithm configured to determine a benefit resulting from the transaction;
transferring transaction information to the provider that includes information about the benefit resulting from the transaction as determined by executing the benefit algorithm;
receiving the benefit from the provider;
executing a recipient algorithm configured to allocate the benefit among one or more recipients based on a hierarchy of members of the network, the hierarchy including an upper line for each member, the upper line of the member including other members of the network that are affiliated with the member and have higher priority in the network than the member, the recipients including the member that entered the transaction and other members in the upper line of the member that entered the transaction; and
dispersing the benefit among the recipients.

2. The method of claim 1, wherein the transaction is an exchange for value between the member and provider and the benefit is a percentage of the value of the exchange.

3. The method of claim 1, wherein the upper line of the member includes a recruiting chain above the member, the recruiting chain above the member including other members of the network that have a recruiting connection with the member and were recruited into the network before the member.

4. The method of claim 1, wherein the recipient algorithm is configured to allocate a percentage of the benefit resulting from the transaction to each recipient.

5. The method of claim 1, wherein the upper line is organized in levels that indicate the priority of the members in the upper line with respect to each other, and the recipient algorithm is configured to allocate the benefit among the recipients in the upper line according to level.

6. The method of claim 1, wherein the recipients further include a third-party that is not a member of the network, the third-party being one or more of a non-profit organization, a charitable organization, a public service organization, a community service organization, an unincorporated association committed to a cause, a trust for a particular purpose, or a fund or pool designated for a purpose.

7. A computer readable medium having a program for administering a benefits network, comprising:
logic configured to receive transaction information from a provider of the network, including information about a transaction between the provider and a member of the network;
logic configured to determine a benefit resulting from the transaction;
logic configured to transfer transaction information to the provider, including information about the benefit resulting from the transaction as determined by the logic configured to determine the benefit;
logic configured to receive the benefit from the provider;
logic configured to allocate the benefit among one or more recipients using a hierarchy of members of the network, the hierarchy including an upper line for each member, the upper line of the member including other members of the network that are affiliated with the member and have higher priority in the network than the member, the recipients including the member that entered the transaction and other members in the upper line of the member that entered the transaction; and
logic configured to disperse the benefit among the recipients.

8. The computer readable medium of claim 7, wherein the transaction is an exchange for value between the member and provider and the benefit is a percentage of the value of the exchange.

9. The computer readable medium of claim 7, wherein the upper line of the member includes a recruiting chain above the member, the recruiting chain above the member including other members of the network that have a recruiting connection with the member and were recruited into the network before the member.

10. The computer readable medium of claim 7, wherein the recipient algorithm is configured to allocate a percentage of the benefit resulting from the transaction to each recipient.

11. The computer readable medium of claim 7, wherein the upper line is organized in levels that indicate the priority of the members in the upper line with respect to each other, and the recipient algorithm is configured to allocate the benefit among the recipients according to level in the upper line.

12. The computer readable medium of claim 7, wherein the recipients further include a third-party that is not a member of the network, the third-party being one or more of a non-profit organization, a charitable organization, a public service organization, a community service organization, an unincorporated association committed to a cause, a trust for a particular purpose, or a fund or pool administered by a third-party.

13. A system for administering a benefits network comprising:
a repository of information about a network, including:
member information that includes an identifier for each member of the network and a hierarchy of members of the network that describes the relationship of members to other members, each member having an upper line in the hierarchy, the upper line of the member including other members that are affiliated with the member and that have higher priority in the network than the member;
provider information that includes an identifier for each provider of the network;
transaction information that includes information about a transaction between the member and provider;
a benefit algorithm configured to determine a benefit resulting from the transaction using information from the repository of information;
a repository of benefits configured to store the benefit; and
a recipient algorithm configured to allocate the benefit among recipients using information input from the repository of information, wherein the recipients include the member that entered the transaction and other members in the upper line of the member that entered the transaction.

14. The system of claim 13, wherein the upper line of the member includes a recruiting chain above the member, the recruiting chain above the member including other members of the network that have a recruiting connection with the member and were recruited into the network before the member.

15. The system of claim 13, wherein the provider information includes benefit rules for the provider, and the benefit algorithm is configured to apply the benefit rules.

16. The system of claim 13, wherein the benefit algorithm accepts transaction information as input and returns the benefit resulting from the transaction as output.

17. The system of claim 13, wherein the recipient algorithm accepts transaction information, including the benefit determined by the benefit algorithm, and member information, including the hierarchy of members of the network, as iput and the recipient algorithm returns an allocation of the benefit among recipients as output.

18. The system of claim 13, wherein the recipients further include a third-party that is not a member of the network, the third-party being one or more of a non-profit organization, a charitable organization, a public service organization, a community service organization, an unincorporated association committed to a cause, a trust for a particular purpose, or a fund or pool administered by a third-party.

19. The system of claim 13, further comprising a computer, wherein the repository of information comprises a database and the algorithms comprise computer programs.

20. The system of claim 13, wherein the system comprises a credit card provider.
